(19) United States
(12) Patent Application Publication
(10) Pub. No.: US 2026/0235087 A1
(43) Pub. Date: Aug. 13, 2026

(54) ENGINE CONTROL DEVICE, VEHICLE, ENGINE CONTROL PROGRAM, AND ENGINE CONTROL METHOD

(71) Applicant: Isuzu Motors Limited, Yokohama-shi (JP)

(72) Inventor: Ryosuke FUJIWARA, Fujisawa-shi (JP)

(73) Assignee: Isuzu Motors Limited, Yokohama-shi (JP)

(21) Appl. No.: 19/537,626

(22) Filed: Feb. 12, 2026

(30) Foreign Application Priority Data
Feb. 13, 2025 (JP) 2025-021636

(51) Int. Cl. F02D 41/02; F02D 13/02; F02D 13/06; F02D 41/00; F02D 41/12

(52) U.S. Cl. CPC F02D 41/0255; F02D 13/0257; F02D 13/06; F02D 41/0002; F02D 41/008; F02D 41/123; F02D 2200/101; F02D 2250/18

(57) ABSTRACT

In a case where a catalyst temperature of a catalyst for purifying exhaust gas of the engine is lower than a first threshold temperature, the engine control device performs compression release control of stopping fuel injection from an injector in a selected cylinder that is one of a plurality of cylinders included in the engine and increasing an amount of fuel injection in a non-selected cylinder different from the selected cylinder, and in a case where the catalyst temperature is equal to or higher than the first threshold temperature, performs Miller cycle control of operating an intake valve such that an amount of intake air is reduced in all of the plurality of cylinders as compared with the case where the catalyst temperature is lower than the first threshold temperature, and reducing the amount of fuel injection.

### RELATED APPLICATIONS

This application claims the benefit of priority of Japanese Patent Application No. 2025-021636 filed on February 13, 2025, the contents of which are incorporated by reference as if fully set forth herein in their entirety.

### TECHNICAL FIELD

The present disclosure relates to an engine control device and a vehicle including the engine control device.

### BACKGROUND ART

In an engine that operates by combusting a mixture of fuel and air, substances such as HC, CO, and NOx are generated in a combustion chamber. In order to purify these substances, a purification catalyst is attached to an exhaust pipe of the engine. In order for the catalyst to sufficiently exhibit a purification ability, it is necessary to heat the catalyst to a predetermined temperature (catalyst activation temperature).

The temperature of the catalyst (catalyst temperature) is controlled by controlling the temperature of exhaust gas discharged from the engine. In a case where the catalyst temperature is low immediately after the engine is started or the like, the engine is controlled such that high-temperature exhaust gas flows through the exhaust pipe in order to quickly raise the catalyst temperature. For example, Patent Literature (hereinafter, referred to as PTL) 1 discloses that, in a case where an SCR catalyst temperature is lower than an activation lower limit temperature, a compression release brake is operated in a predetermined cylinder. In the compression release brake, the amount of negative work is generated, and a correction is applied to increase the amount of fuel injection to compensate for the loss of the work amount. As a result, the amount of generated heat of the entire engine is increased, and an increase in the exhaust temperature heats the SCR catalyst.

### CITATION LIST

### Patent Literature

### PTL 1

Japanese Patent Application Laid-Open No. 2012-219804

### SUMMARY OF INVENTION

### Technical Problem

In the conventional technique, a method for increasing the amount of fuel injection of the engine in order to quickly raise the catalyst temperature has been used. However, this method has a problem in that fuel economy deteriorates. In addition, there is a problem in that it is difficult to perform control for maintaining an appropriate temperature even after the catalyst temperature reaches the predetermined temperature.

An object of the present disclosure is to solve these problems and to provide an engine control device capable of quickly raising a catalyst temperature and maintaining the appropriate temperature.

### Solution to Problem

An engine control device according to the present disclosure controls an engine. The engine control device performs compression release control of stopping fuel injection from an injector in a selected cylinder and increasing an amount of fuel injection in a non-selected cylinder different from the selected cylinder, in a case where a catalyst temperature of a catalyst for purifying exhaust gas of the engine is lower than a first threshold temperature, the selected cylinder being one or some of a plurality of cylinders included in the engine, and performs Miller cycle control of operating an intake valve such that an amount of intake air is reduced in all of the plurality of cylinders as compared with the case where the catalyst temperature is lower than the first threshold temperature, and reducing the amount of fuel injection, in a case where the catalyst temperature is equal to or higher than the first threshold temperature.

### Advantageous Effects of Invention

According to the present disclosure, in the case where the catalyst temperature is lower than the first catalyst temperature indicating an activation state of the catalyst, the catalyst is rapidly heated by increasing the exhaust gas temperature by operating the engine while applying a load to the engine by the compression release control, and after the catalyst temperature reaches the first catalyst temperature or higher, the catalyst temperature can be optimally controlled by maintaining the exhaust gas temperature while improving fuel economy by the Miller cycle control.

### BRIEF F DESCRIPTION OF DRAWINGS

FIG. 1 is a schematic diagram of a vehicle;

FIG. 2A is a diagram illustrating an operation of engine control;

FIG. 2B is a diagram illustrating an operation of engine control;

FIG. 2C is a diagram illustrating an operation of engine control;

FIG. 2D is a diagram illustrating an operation of engine control;

FIG. 3 is a flowchart of an engine control device;

FIG. 4 is a diagram illustrating a relationship between a catalyst temperature and a purification rate;

FIG. 5 is a diagram illustrating a relationship between a catalyst temperature, a coolant temperature, and switching of driving control; and

FIG. 6 is another example of the flowchart of the engine control device.

### DESCRIPTION OF EMBODIMENTS

Hereinafter, embodiments of the present disclosure will be described with reference to the accompanying drawings. All the embodiments described below show specific examples of the present disclosure. Therefore, each component, the position and connection form of each component, and the like illustrated in the following embodiments are merely examples and are not intended to limit the present disclosure. In addition, components that are not recited in the independent claims among components in the following embodiments are described as optional components.

Each drawing is a schematic diagram and is not necessarily a strict illustration. In each drawing, substantially identical configurations are denoted by the same reference numeral, and redundant explanations may be omitted or simplified.

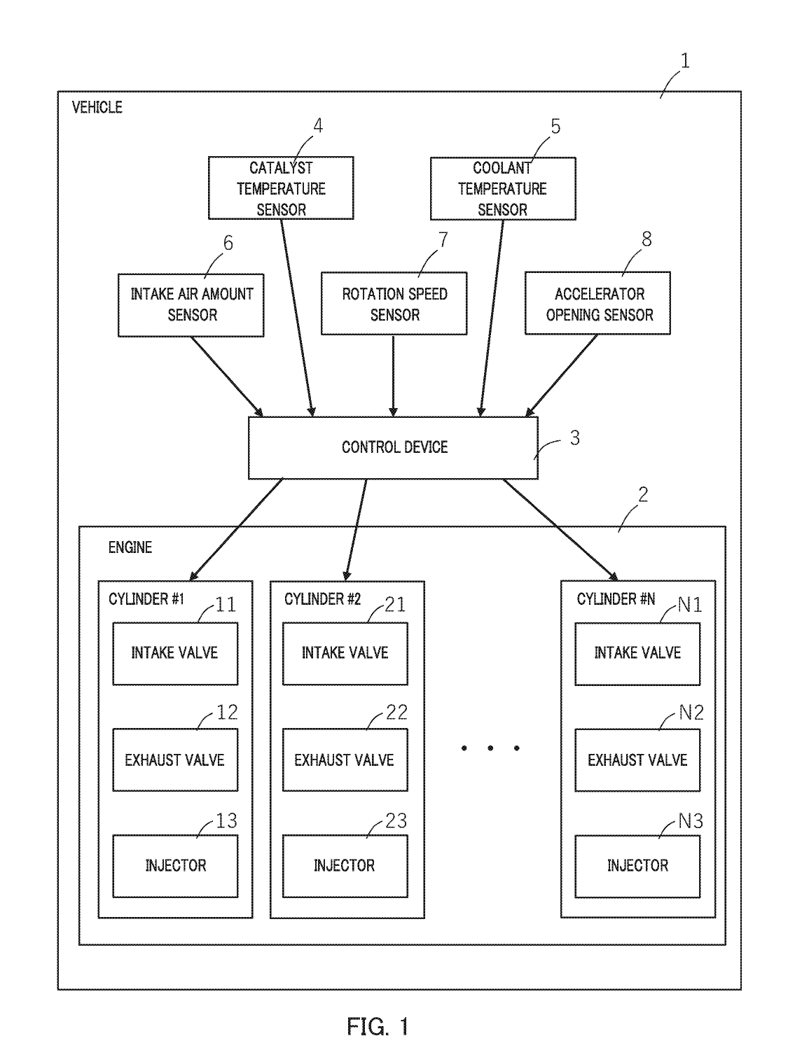

FIG. 1 illustrates an outline of a configuration of a vehicle according to the embodiment of the present disclosure. Vehicle 1 includes engine 2, various sensors 4, 5, 6, 7, and 8 that detect states of respective parts of the vehicle, and control device 3 that controls the operation of engine 2 based on data acquired from various sensors 4, 5, 6, 7, and 8.

Engine 2 combusts and expands a mixture of fuel and air to generate power. Engine 2 is a diesel engine, for example, but may be a gasoline engine. Engine 2 includes a plurality of cylinders (cylinder #1, cylinder #2, ..., and cylinder #N). The mixture of fuel and air is combusted and expanded inside each cylinder, and a piston provided in each cylinder moves up and down. A crankshaft is connected to the piston, and the up-down motion of the piston is extracted as rotational motion of the crankshaft to serve as motive power of vehicle 1. An intake pipe and an exhaust pipe are connected to each cylinder. The intake pipe introduces air to each cylinder. The exhaust pipe discharges, into the atmosphere, exhaust gas generated in each cylinder by combustion.

Each of the plurality of cylinders (cylinder #1, cylinder #2, ..., and cylinder #N) includes an intake valve, an exhaust valve, and an injector. The intake valve is a valve that is disposed between each cylinder and the intake pipe and is operated in an openable and closable manner. When the intake valve is opened, air is introduced from the intake pipe to each cylinder, and when the intake valve is closed, the introduction of air from the intake pipe to each cylinder is blocked. The exhaust valve is a valve that is disposed between each cylinder and the exhaust pipe and is operated in an openable and closable manner. When the exhaust valve is opened , exhaust gas is discharged from each cylinder to the exhaust pipe, and when the exhaust valve is closed, the discharge of exhaust gas from each cylinder to the exhaust pipe is blocked. The injector performs fuel injection toward the inside of each cylinder. Cylinder #1 includes intake valve 11, exhaust valve 12, and injector 13. Similarly, cylinder #2 includes intake valve 21, exhaust valve 22, and injector 23, and cylinder #N includes intake valve N1, exhaust valve N2, and injector N3. In other words, cylinder #1, cylinder #2, …, and cylinder #N respectively include intake valve 11, intake valve 21, …, and intake valve N1; respectively include exhaust valve 12, exhaust valve 22, …, and exhaust valve N2; and respectively include injector 13, injector 23, …, and injector N3.

Catalyst temperature sensor 4 detects a catalyst temperature of a catalyst (not illustrated). Here, the catalyst is provided in the exhaust pipe and purifies the exhaust gas of engine 2. The catalyst is, for example, a selective catalytic reduction (SCR) catalyst in a case where engine 2 is a diesel engine. Catalyst temperature sensor 4 is provided in the catalyst or the exhaust pipe. Coolant temperature sensor 5 detects a coolant temperature that is a temperature of a coolant for cooling engine 2. The coolant is, for example, cooling water. A cooling device (not illustrated) that cools engine 2 is provided in engine 2. Coolant temperature sensor 5 is provided in a coolant circuit included in the cooling device. Coolant temperature sensor 5 detects the coolant temperature of the coolant that circulates inside the coolant circuit for cooling engine 2.

By detecting the coolant temperature with coolant temperature sensor 5, information related to an engine temperature that is a temperature of engine 2 can be obtained. In the operation of engine 2, it is desired to keep the engine temperature within an appropriate range. For example, when engine 2 is not warmed up yet immediately after the start of engine 2, the viscosity of the lubricating oil of engine 2 may increase, and a load on engine 2 may increase. In addition, when engine 2 is not warmed up yet, a cooling loss in the combustion of the fuel may increase, and the fuel economy may decrease. In order to prevent these, engine 2 is controlled based on the coolant temperature, and the engine temperature is controlled to be within an appropriate range. Specifically, the engine temperature may be kept within the appropriate range by controlling engine 2 so as to increase the amount of heat generation of engine 2.

Intake air amount sensor 6 is provided in the intake pipe (not illustrated) and detects an amount of intake air into engine 2. Here, the amount of intake air indicates an amount of air introduced into the cylinder during fuel injection in each cylinder. Rotation speed sensor 7 is provided on the crankshaft (not illustrated) and detects a rotation speed of engine 2 (crankshaft). Accelerator opening sensor 8 is provided on an accelerator pedal (not illustrated) and detects an operation amount of the accelerator pedal. The driver of vehicle 1 can increase the requested output of engine 2 by increasing the operation amount of the accelerator pedal and can decrease the requested output of engine 2 by decreasing the operation amount.

Control device 3 is a computer provided in vehicle 1. Control device 3 includes a calculation device such as a central processing unit (CPU), a storage device such as a memory, a communication interface, and the like, and controls the operation of engine 2 in accordance with an engine control program stored in the storage device. Control device 3 selects any one of a plurality of controls including normal control, Miller cycle control, and compression release control based on the data acquired by the various sensors, and controls engine 2.

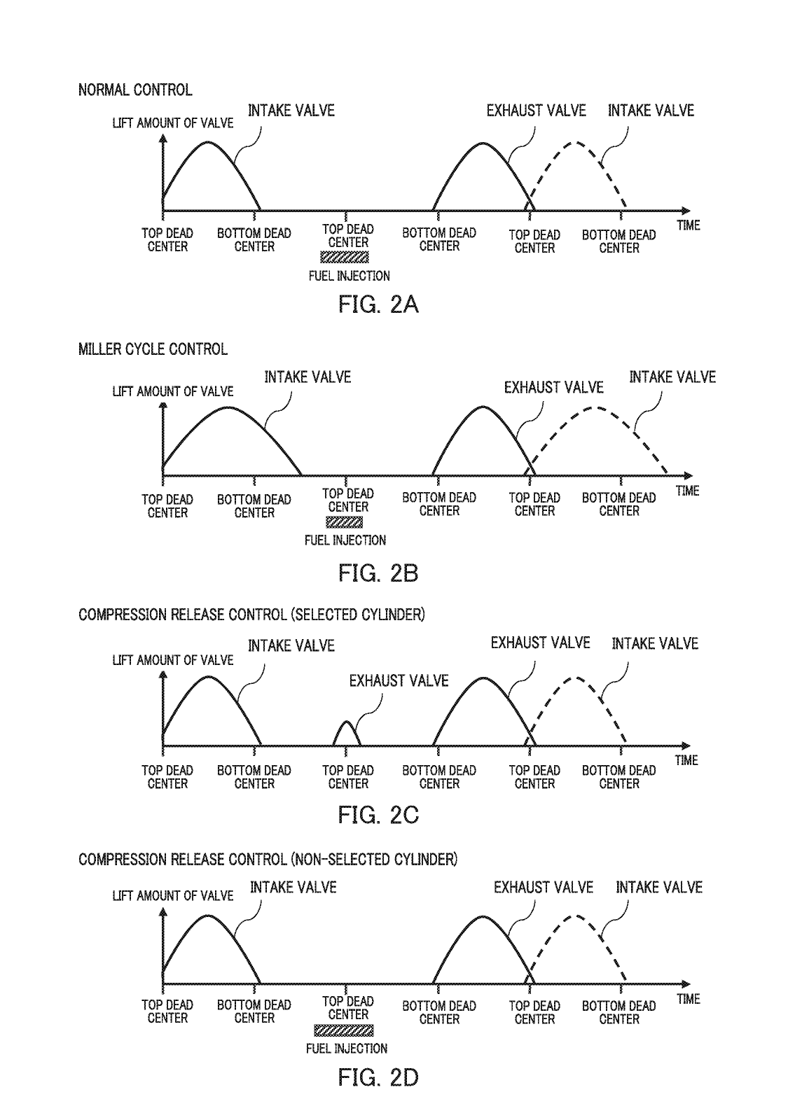

FIG. 2 is a diagram illustrating operations of the exhaust valve, the intake valve, and the fuel injection for each control of engine 2. A horizontal axis in FIG. 2 indicates a time elapsed in the combustion cycle, and a vertical axis indicates a lift amount of the intake valve or the exhaust valve. The top dead center or the bottom dead center indicated as graduations on the horizontal axis in FIG. 2 indicates a time at which the position of the piston is at the top dead center or the bottom dead center. The lift amount on the vertical axis in FIG. 2 indicates that the intake valve or the exhaust valve is opened as the lift amount increases, and indicates that the intake valve or the exhaust valve is closed as the lift amount decreases. FIG. 2A is a diagram illustrating an operation in the combustion cycle of the normal control. FIG. 2B is a diagram illustrating an operation in the combustion cycle of the Miller cycle control. FIG. 2C is a diagram illustrating an operation in the combustion cycle of the compression release control in the selected cylinder, and FIG. 2D is a diagram illustrating an operation in the combustion cycle of the compression release control in the non-selected cylinder.

Here, the combustion cycle of the normal control will be described focusing on one cylinder (cylinder #1). FIG. 2A is a diagram illustrating an operation in the combustion cycle of the normal control. As illustrated in FIG. 2A, in the combustion cycle of the normal control, first, air is introduced into cylinder #1. Only intake valve 11 is opened while the piston is descending from the top dead center, and air is introduced into cylinder #1 (intake stroke). Next, intake valve 11 is closed when the piston is positioned near the bottom dead center. The piston rises to the top dead center in a state where intake valve 11 and exhaust valve 12 are closed. Thus, the air introduced into cylinder #1 is compressed (compression stroke). Subsequently, injector 13 performs fuel injection into the cylinder when the piston is positioned at the top dead center. Accordingly, the fuel mixed with the compressed air is combusted, and the piston is pushed down to the bottom dead center by the expanded combustion gas (combustion stroke). Then, only exhaust valve 12 is opened when the piston rises to the top dead center again due to inertia or expansion in the other cylinder, which pushes the combustion gas outside cylinder #1 and discharges the combustion gas into the atmosphere as exhaust gas (exhaust stroke). Upon the piston rising to the top dead center, intake valve 11 is opened while the piston is descending toward the bottom dead center again, and air is introduced into cylinder #1. In this way, engine 2 generates power by repeating the intake stroke, the compression stroke, the combustion stroke, and the exhaust stroke.

In the normal control, the intake valve is closed when the piston is positioned near the bottom dead center in all of the plurality of cylinders, and the fuel injection is performed when the piston is positioned near the top dead center. The amount of heat generation in the case of the combustion cycle of the normal control is less than that in the compression release control described later and greater than that in the Miller cycle control described later. Therefore, the engine can be warmed up while preventing the catalyst temperature from being excessively high before the engine is warmed up.

In the Miller cycle control, the intake valve is operated to reduce the amount of intake air in all of the plurality of cylinders as compared with the case of the normal control and the case of the compression release control described later, and the amount of fuel injection is controlled to be further reduced. FIG. 2B is a diagram illustrating an operation in the combustion cycle of the Miller cycle control. In the Miller cycle control, as in the normal control, first, air is introduced into cylinder #1. Only intake valve 11 is opened while the piston is descending from the top dead center, and air is introduced into cylinder #1 (intake stroke). Next, the piston reaches the bottom dead center. Here, in the Miller cycle control, unlike the normal control, intake valve 11 is not closed when the piston reaches the bottom dead center, and intake valve 11 is closed after the piston starts to rise toward the top dead center again. For example, intake valve 11 is closed after the piston passes a position between the bottom dead center and the top dead center. Thereafter, the piston rises to the top dead center in a state where intake valve 11 and exhaust valve 12 are closed. Thus, the air introduced into cylinder #1 is compressed (compression stroke). Subsequently, injector 13 performs fuel injection into the cylinder when the piston is positioned at the top dead center. This combusts the fuel mixed with the compressed air, and the piston is pushed down to the bottom dead center by the expanded combustion gas (combustion stroke). Then, only exhaust valve 12 is opened when the piston rises to the top dead center again due to inertia or expansion in the other cylinder, which pushes the combustion gas outside cylinder #1 and discharges the combustion gas into the atmosphere as exhaust gas (exhaust stroke). Upon the piston rising to the top dead center, intake valve 11 is opened while the piston is descending toward the bottom dead center again, and air is introduced into cylinder #1.

In the Miller cycle control, the amount of intake air is reduced in the plurality of cylinders of engine 2 as compared with the normal control. For example, as illustrated in FIG. 2B, “late closing” control of closing intake valve 11 later than in the case of the normal control and the compression release control is performed in the intake stroke. In addition, intake valve 11 may be controlled to be closed in the middle of the intake stroke. That is, “quick closing” control of closing intake valve 11 earlier than in the case of the normal control may be performed.

In the Miller cycle control, as the amount of intake air to cylinder #1 is reduced as compared with the normal control, the amount of fuel injection required for each cylinder is reduced. For example, as illustrated in FIG. 2B, a period in which the fuel injection is performed may be shortened. By reducing the amount of fuel injection, engine 2 generates power with less fuel. That is, because vehicle 1 can travel with less fuel, the fuel economy is improved as compared with the normal control. Meanwhile, although the amount of fuel injection is reduced, when the amount of gas in cylinder #1 is reduced, the heat capacity reduces, making it easier to maintain the temperature of the exhaust gas from combustion. Therefore, the catalyst temperature can be maintained at an appropriate temperature by suppressing the decrease in the catalyst temperature below the activation temperature.

Next, the combustion cycle of the compression release control will be described. In the compression release control, one or some of the plurality of cylinders of engine 2 are selected as selected cylinders that perform the combustion cycle of the compression release control. The non-selected cylinder different from the selected cylinder among the plurality of cylinders performs the same combustion cycle as the normal control.

The combustion cycle of the selected cylinder in the compression release control will be described. FIG. 2C is a diagram illustrating an operation in the combustion cycle of the compression release control in the selected cylinder. In the selected cylinder in the compression release control, as in the normal control, first, air is introduced into cylinder #1. Intake valve 11 is opened while the piston is descending from the top dead center, and air is introduced into cylinder #1 (intake stroke). Next, intake valve 11 is closed when the piston descends to the bottom dead center, and the piston rises to the top dead center in a state where intake valve 11 and exhaust valve 12 are closed. Thus, the air introduced into cylinder #1 is compressed (compression stroke). Here, in the selected cylinder in the compression release control, unlike the normal control, exhaust valve 12 is opened when the piston is positioned at the top dead center in the compression stroke. In addition, unlike the normal control, the fuel injection is not performed while the piston is positioned at the top dead center. Subsequently, after the piston passes the top dead center, exhaust valve 12 is closed again. Then, the piston descends toward the bottom dead center in a state where intake valve 11 and exhaust valve 12 are closed (expansion stroke). Then, only exhaust valve 12 is opened when the piston rises to the top dead center again due to inertia or expansion in the other cylinder, and the gas inside cylinder #1 is pushed outside (exhaust stroke). Upon the piston rising to the top dead center, intake valve 11 is opened while the piston is descending toward the bottom dead center again, and air is introduced into cylinder #1.

Meanwhile, in the non-selected cylinder in the compression release control, the combustion cycle is performed in the same manner as in the normal control. FIG. 2D is a diagram illustrating an operation in the combustion cycle of the compression release control in the non-selected cylinder. In the non-selected cylinder in the compression release control, first, air is introduced into cylinder #1. Only intake valve 11 is opened while the piston is descending from the top dead center, and air is introduced into cylinder #1 (intake stroke). Next, intake valve 11 is closed when the piston reaches the bottom dead center, and the piston rises to the top dead center in a state where intake valve 11 and exhaust valve 12 are closed. This causes the air introduced into cylinder #1 to be compressed (compression stroke). Subsequently, injector 13 performs fuel injection into the cylinder when the piston is positioned at the top dead center. Thus, the fuel mixed with the compressed air is combusted, and the piston is pushed down to the bottom dead center by the expanded combustion gas (combustion stroke). Then, only exhaust valve 12 is opened when the piston rises to the top dead center again due to inertia or expansion in the other cylinder, which pushes the combustion gas outside cylinder #1 and discharges the combustion gas into the atmosphere as exhaust gas (exhaust stroke). Upon the piston rising to the top dead center, intake valve 11 is opened while the piston is descending toward the bottom dead center, and air is introduced into cylinder #1.

In the compression release control, the selected cylinder is appropriately selected according to the displacement, the number of cylinders, the rotation speed, the requested load, and the like of engine 2. For example, in the case of a four-cylinder engine including cylinder #1, cylinder #2, cylinder #3, and cylinder #4, the combustion cycle illustrated in FIG. 2C may be performed in two cylinders of cylinder #1 and cylinder #4 as selected cylinders, and the combustion cycle illustrated in FIG. 2D may be continued in two cylinders of cylinder #2 and cylinder #3 as non-selected cylinders. Alternatively, the combustion cycle illustrated in FIG. 2C may be performed in two cylinders of cylinder #2 and cylinder #3 as selected cylinders, and the combustion cycle illustrated in FIG. 2D may be continued in two cylinders of cylinder #1 and cylinder #4 as non-selected cylinders.

In the compression release control, the fuel injection from the injector is stopped in the selected cylinder that is one of the plurality of cylinders, and the amount of fuel injection is increased in the non-selected cylinder different from the selected cylinder. In the compression release control, the output is reduced by stopping the fuel injection in the selected cylinder, and the output is compensated by increasing the amount of fuel injection in the non-selected cylinder. For example, as illustrated in FIG. 2D, a period in which the fuel injection is performed may be lengthened.

The selected cylinder enters a state where the engine brake is applied. In the selected cylinder, during the compression stroke, the air inside the cylinder is compressed. This generates a load that resists rotation of engine 2. Further, the exhaust valve is opened when the piston is positioned near the top dead center, and the exhaust valve is closed again after the compressed air is discharged. Thus, the pressure inside the cylinder is reduced in the expansion stroke, and a load is generated to resist engine 2. In the non-selected cylinder, it is necessary to obtain an output that exceeds the load, and thus it is necessary to perform more fuel injection. Therefore, the amount of heat generation in the non-selected cylinder is greater than that in the case of the normal control, and the temperature of the exhaust gas is also higher than that in the case of the normal control. In addition, the high-temperature air compressed in the compression stroke is discharged from the selected cylinder. This can effectively increase the exhaust gas temperature and rapidly increase the catalyst temperature.

Control device 3 acquires the catalyst temperature from catalyst temperature sensor 4 and acquires the coolant temperature from coolant temperature sensor 5. Control device 3 controls the operations of intake valves 11, 21, ..., and N1, exhaust valves 12, 22, ..., and N2, and injectors 13, 23, ..., and N3 based on these temperature data.

In addition, control device 3 may acquire the amount of intake air from intake air amount sensor 6, acquire the rotation speed of the engine from rotation speed sensor 7, and acquire the accelerator opening from accelerator opening sensor 8. Control device 3 may control the operations of intake valves 11, 21, ..., and N1, exhaust valves 12, 22, ..., and N2, and injectors 13, 23, ..., and N3 based on these data.

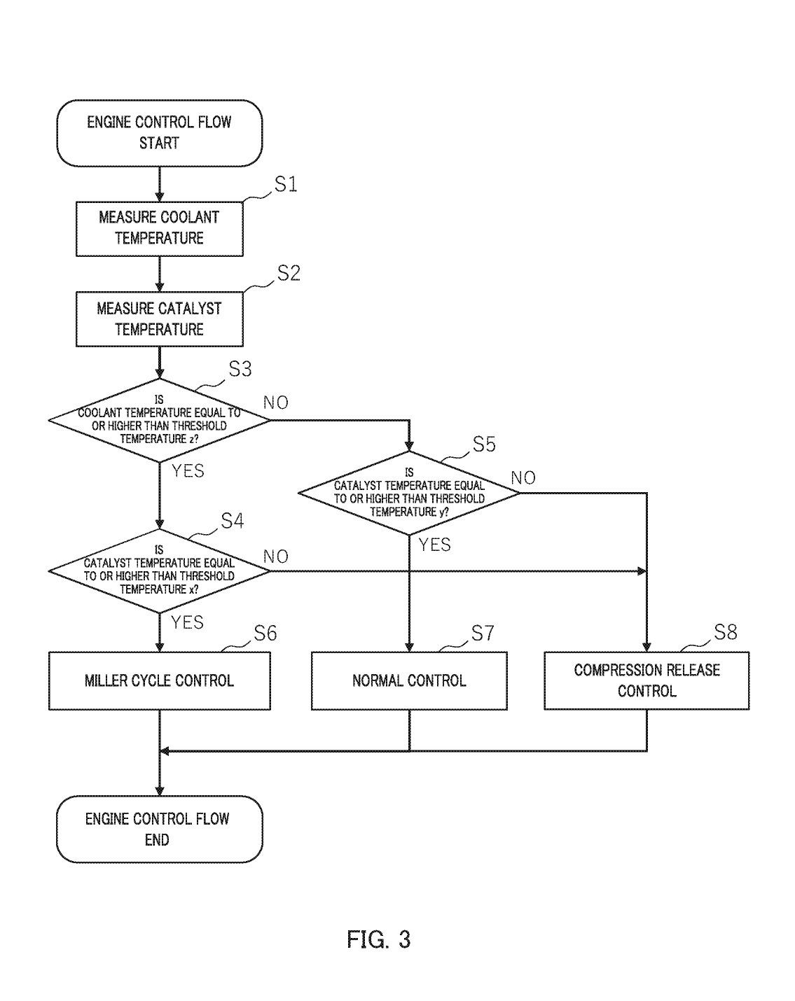

FIG. 3 is a flowchart of control device 3 controlling the operation of engine 2 in accordance with the engine control program. Control device 3 acquires the coolant temperature from coolant temperature sensor 5 (Step S1). In addition, control device 3 acquires the catalyst temperature from catalyst temperature sensor 4 (Step S2). Then, control device 3 determines whether the coolant temperature is equal to or higher than predetermined threshold temperature z (°C) (second threshold temperature) (Step S3). Here, threshold temperature z is a lower limit temperature indicating that engine 2 is in a warmed-up state. In a case where the coolant temperature is lower than threshold temperature z, engine 2 is in a cold state in which the temperature is low, and in a case where the coolant temperature is equal to or higher than threshold temperature z, engine 2 is in a warmed-up state in which the temperature is high. Threshold temperature z is, for example, 100°C.

In a case where the coolant temperature is equal to or higher than threshold temperature z (Yes in Step S3), control device 3 determines whether the catalyst temperature is equal to or higher than threshold temperature x (°C) (first threshold temperature) (Step S4). On the other hand, in a case where the coolant temperature is lower than threshold temperature z (NO in Step S3), control device 3 determines whether the catalyst temperature is equal to or higher than threshold temperature y (°C) (third threshold temperature) (Step S5).

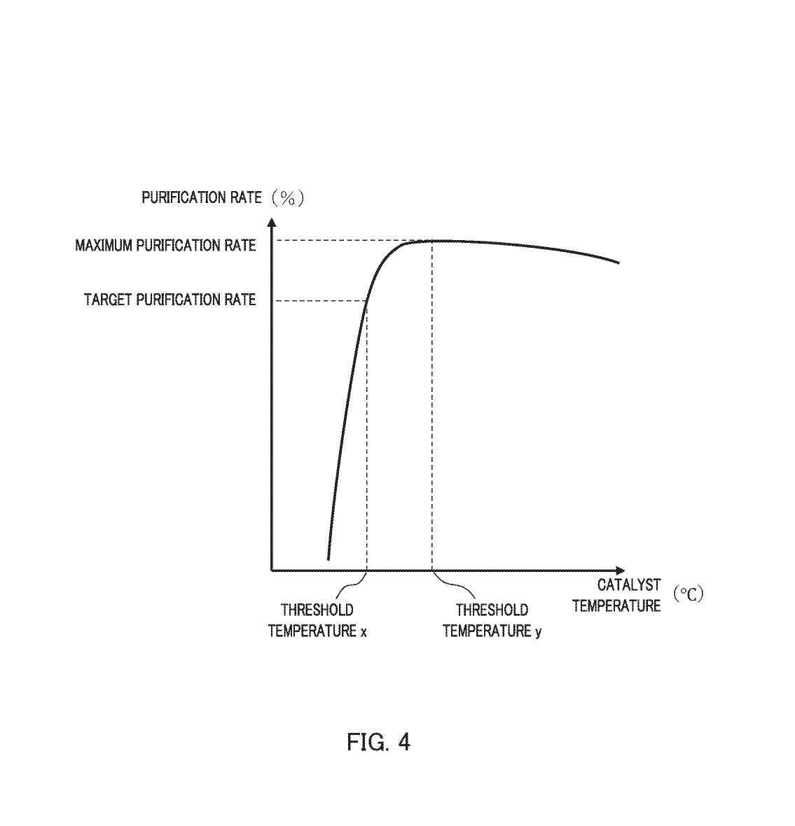

Here, threshold temperature x is an upper limit temperature indicating that the catalyst needs to be heated, and threshold temperature y is a lower limit temperature indicating that the catalyst does not need to be heated. Threshold temperature x is a temperature lower than threshold temperature y. Here, FIG. 4 illustrates a relationship between the catalyst temperature and the purification rate of the catalyst. The purification rate of the catalyst has a curved relationship with respect to the catalyst temperature. For example, threshold temperature x is a catalyst temperature at which the purification rate of the catalyst becomes a target purification rate that is a predetermined target value. In addition, threshold temperature y is a temperature at which the catalyst is completely activated, and is a temperature at which the purification rate of the catalyst becomes a maximum purification rate. For example, threshold temperature x is 150°C, and threshold temperature y is 300°C. Threshold temperature x and threshold temperature y can be appropriately determined according to the type and/or deterioration state of the catalyst of engine 2, the number of cylinders and/or the displacement of engine 2, and the like.

In a case where the catalyst temperature is equal to or higher than threshold temperature x in Step S4 (Yes in Step S4), control device 3 performs the Miller cycle control (Step S6). On the other hand, in a case where the catalyst temperature is lower than threshold temperature x in Step S4 (NO in Step S4), control device 3 performs the compression release control (Step S8).

In addition, in a case where the catalyst temperature is equal to or higher than threshold temperature y in Step S5 (Yes in Step S5), control device 3 performs the normal control (Step S7). On the other hand, in a case where the catalyst temperature is lower than threshold temperature y in Step S5 (No in Step S5), control device 3 performs the compression release control (Step S8).

The flowchart is repeatedly performed while the vehicle is traveling. Then, when the coolant temperature or the catalyst temperature changes and the determination results of Steps S3 to S5 change, the control content is changed from the compression release control to the normal control or the Miller cycle control, from the normal control to the compression release control or the Miller cycle control, or from the Miller cycle control to the normal control or the compression release control. At this time, in the case of transitioning from the normal control or the Miller cycle control to the compression release control, the fuel injection into the selected cylinder is stopped, and the amount of fuel injection is increased in the non-selected cylinder, and then the transition is performed. In addition, in the case of transitioning from the compression release control to the normal control or the Miller cycle control, the fuel injection into the selected cylinder is restarted after the transition, and the amount of fuel injection is reduced in the non-selected cylinder. This makes it possible to prevent the fuel that is not combusted during the compression release control from being discharged and to suppress the torque fluctuation due to a rapid change in the amount of fuel injection.

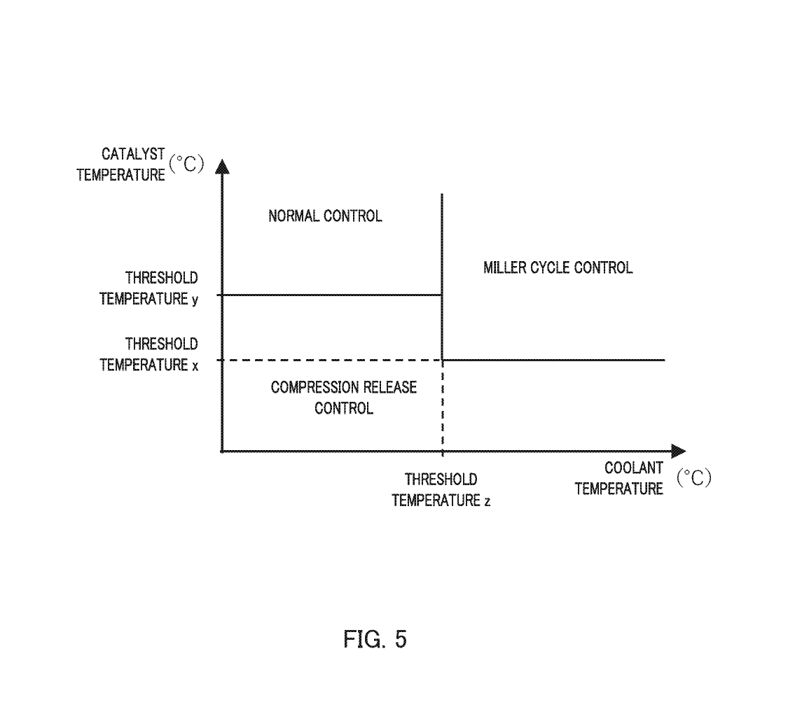

FIG. 5 is a diagram illustrating a determination criterion for determining which of the Miller cycle control, the compression release control, or the normal control is performed according to the coolant temperature and the catalyst temperature. In a case where the coolant temperature is equal to or higher than threshold temperature z that is a lower limit temperature indicating that the engine is warmed up, and the catalyst temperature is equal to or higher than threshold temperature x that is an upper limit temperature indicating that the catalyst needs to be heated, the Miller cycle control is performed. In addition, in a case where the coolant temperature is equal to or higher than threshold temperature z, and the catalyst temperature is lower than threshold temperature x, the compression release control is performed.

In a case where the coolant temperature is equal to or higher than threshold temperature z, and the catalyst temperature is equal to or higher than threshold temperature x, engine 2 is in a warmed-up state, and thus it is not necessary to warm engine 2 any further. Furthermore, the catalyst temperature has reached threshold temperature x, and thus it is not necessary to warm the catalyst any further. Therefore, by employing the Miller cycle control to suppress the amount of heat generation of engine 2 while suppressing a decrease in the exhaust gas temperature, the catalyst temperature is appropriately controlled.

In a case where the coolant temperature is equal to or higher than threshold temperature z, and the catalyst temperature is lower than threshold temperature x, engine 2 is in a warmed-up state, but the catalyst temperature has not reached threshold temperature x. Therefore, the exhaust gas temperature is increased by the compression release control, which has a large amount of heat generation, to raise the catalyst temperature.

In a case where the coolant temperature is lower than threshold temperature z, and the catalyst temperature is equal to or higher than threshold temperature y that is a lower limit temperature indicating that the catalyst does not need to be heated, the normal control is performed. In addition, in a case where the coolant temperature is lower than threshold temperature z, and the catalyst temperature is lower than threshold temperature y, the compression release control is performed.

In the case where the coolant temperature is lower than threshold temperature z, and the catalyst temperature is equal to or higher than threshold temperature y, engine 2 needs to be warmed up, but the catalyst temperature does not need to be increased. Therefore, by making, by the normal control, the amount of heat generation of engine 2 greater than that in the Miller cycle control and less than that in the compression release control, the catalyst temperature is appropriately controlled by maintaining the exhaust gas temperature while warming engine 2.

In the case where the coolant temperature is lower than threshold temperature z and the catalyst temperature is lower than threshold temperature y, engine 2 needs to be warmed up, and the catalyst temperature also needs to be increased. Therefore, by the compression release control, which has a large amount of heat generation, engine 2 is heated by increasing the amount of heat generation of engine 2 while the exhaust gas temperature is increased, so that the catalyst temperature is increased.

As described above, because the operation of engine 2 is controlled based on the coolant temperature and the catalyst temperature to control the temperature of the exhaust gas, the catalyst temperature and the engine temperature can be appropriately controlled, and harmful substances in the exhaust gas can be appropriately decomposed and removed.

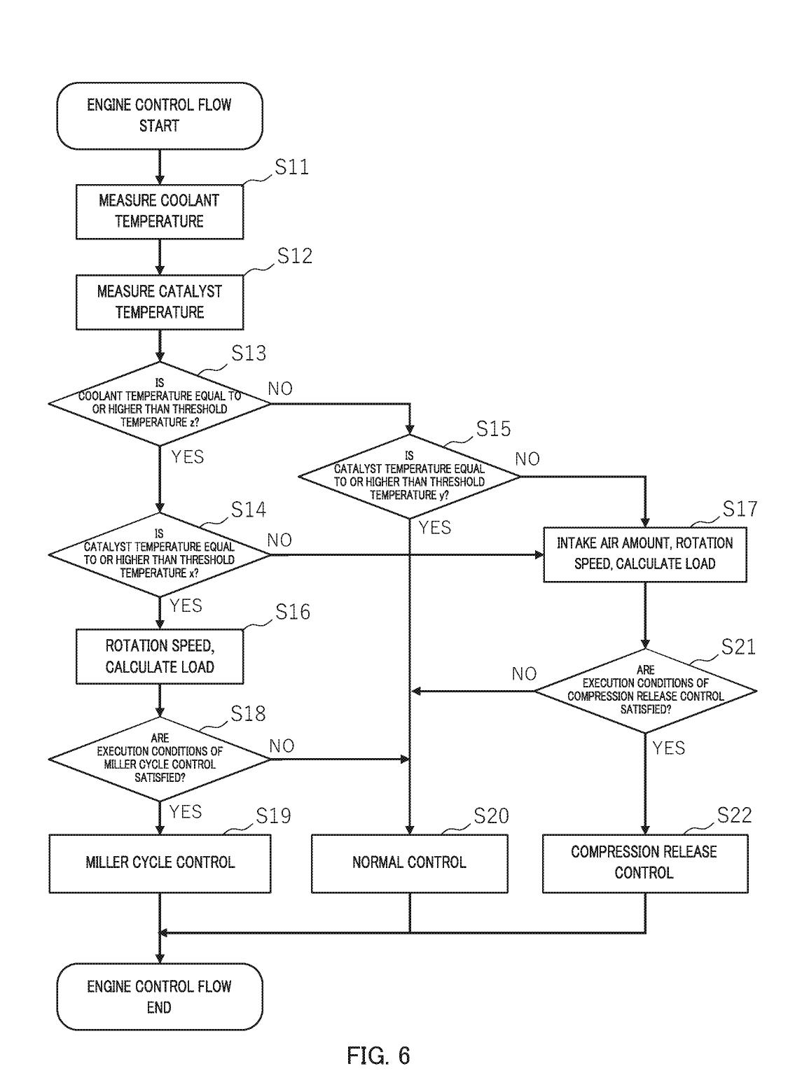

FIG. 6 is a flowchart of another example of the operation of control device 3. Control device 3 acquires the coolant temperature from coolant temperature sensor 5 (Step S11). In addition, control device 3 acquires the catalyst temperature from catalyst temperature sensor 4 (Step S12). Then, control device 3 determines whether the coolant temperature is equal to or higher than predetermined threshold temperature z (Step S13). Here, threshold temperature z is a temperature indicating the warmed-up state of engine 2.

In a case where the coolant temperature is equal to or higher than threshold temperature z (Yes in Step S13), control device 3 determines whether the catalyst temperature is equal to or higher than threshold temperature x (Step S14). Here, threshold temperature x is an upper limit temperature indicating that the catalyst needs to be heated. On the other hand, in a case where the coolant temperature is lower than threshold temperature z (No in Step S13), control device 3 determines whether the catalyst temperature is equal to or higher than threshold temperature y (Step S15). Here, threshold temperature y is a lower limit temperature indicating that the catalyst does not need to be heated, and is a value higher than threshold temperature x.

In a case where the catalyst temperature is equal to or higher than threshold temperature x in Step S14 (Yes in Step S14), control device 3 acquires the rotation speed of engine 2 from rotation speed sensor 7 and calculates the requested output (engine load) based on the accelerator opening acquired from accelerator opening sensor 8 (Step S16). Then, in a case where the rotation speed of engine 2 and the requested output match the execution conditions of the Miller cycle control (Yes in Step S18), control device 3 drives engine 2 by the Miller cycle control (Step S19). For example, the Miller cycle control is performed in a case where the rotation speed is lower than a predetermined rotation speed and the requested output is lower than a predetermined requested output. On the other hand, in a case where the rotation speed of engine 2 and the requested output do not match the execution conditions of the Miller cycle control (No in Step S18), control device 3 drives engine 2 by the normal control (Step S20).

In the Miller cycle control, the amount of intake air is small, and thus there are upper limits for the rotation speed and the requested output. Therefore, in Step S18, it is determined whether the rotation speed and the requested output are suitable for the Miller cycle control. Specific values of the predetermined rotation speed and the predetermined requested output can be appropriately determined according to the number of cylinders and/or the displacement of engine 2.

On the other hand, in a case where the catalyst temperature is lower than threshold temperature x in Step S14 (No in Step S14), control device 3 acquires the amount of intake air from intake air amount sensor 6, acquires the rotation speed of engine 2 from rotation speed sensor 7, and calculates the requested output (engine load) based on the accelerator opening acquired from accelerator opening sensor 8 (Step S17). Then, in a case where the amount of intake air, the rotation speed of engine 2, and the requested output match the execution conditions of the compression release control (Yes in Step S21), control device 3 drives engine 2 by the compression release control (Step S22). For example, the compression release control is performed in a case where the rotation speed is lower than a predetermined rotation speed, the requested output is lower than a predetermined requested output, and the amount of intake air is a predetermined amount of intake air. On the other hand, in a case where the amount of intake air, the rotation speed of engine 2, and the requested output do not match the execution conditions of the compression release control (No in Step S21), control device 3 drives engine 2 by the normal control (Step S20).

In the compression release control, the fuel injection of one or some of the cylinders is stopped, and only the remaining cylinder performs the fuel injection. When the number of cylinders performing the fuel injection decreases, vibration tends to occur, which is not suitable for operation at low speed. In addition, there is a concern that the requested output cannot be produced when the amount of intake air is small. Thus, in Step S21, it is determined whether the amount of intake air, the rotation speed of engine 2, and the requested output are suitable for the compression release control. Specific values of the predetermined amount of intake air, the predetermined rotation speed, and the predetermined requested output can be appropriately determined according to the number of cylinders or the displacement of engine 2.

In a case where the catalyst temperature is equal to or higher than threshold temperature y in Step S15 (Yes in Step S15), control device 3 drives engine 2 by the normal control (Step S20). On the other hand, in a case where the catalyst temperature is lower than threshold temperature y in Step S15 (No in Step S15), control device 3 acquires the amount of intake air from intake air amount sensor 6, acquires the rotation speed of engine 2 from rotation speed sensor 7, and calculates the requested output (engine load) based on the accelerator opening acquired from accelerator opening sensor 8 (Step S17). Then, in a case where the amount of intake air, the rotation speed of engine 2, and the requested output match the execution conditions of the compression release control (Yes in Step S21), control device 3 drives engine 2 by the compression release control (Step S22), and in a case where the amount of intake air, the rotation speed of engine 2, and the requested output do not match the execution conditions of the compression release control (No in Step S21), control device 3 drives engine 2 by the normal control (Step S20).

As described above, since engine 2 is controlled based on the amount of intake air, the rotation speed of engine 2, and the requested output (engine load) in addition to the coolant temperature and the catalyst temperature to control the temperature of the exhaust gas, the Miller cycle control and the compression release control can be performed under appropriate conditions, the catalyst temperature and the engine temperature can be appropriately controlled, and harmful substances in the exhaust gas can be appropriately decomposed and removed.

### Industrial Applicability

The vehicle according to the present disclosure can be widely used in the automotive industry. In particular, the present disclosure is useful in a field in which optimal control of a catalyst temperature is required in an exhaust gas purification device of an engine.

### REFERENCE SIGNS LIST

1 Vehicle

2 Engine

3 Control device

4 Catalyst temperature sensor

5 Coolant temperature sensor

6 Intake air amount sensor

7 Rotation speed sensor

8 Accelerator opening sensor

11, 21, N1 Intake valve

12, 22, N2 Exhaust valve

13, 23, N3 Injector

1. An engine control device that controls an engine, wherein
the engine control device performs compression release control of stopping fuel injection from an injector in a selected cylinder and increasing an amount of fuel injection in a non-selected cylinder different from the selected cylinder, in a case where a catalyst temperature of a catalyst for purifying exhaust gas of the engine is lower than a first threshold temperature, the selected cylinder being one or some of a plurality of cylinders included in the engine, and
the engine control device performs Miller cycle control of operating an intake valve such that an amount of intake air is reduced in all of the plurality of cylinders as compared with the case where the catalyst temperature is lower than the first threshold temperature, and reducing the amount of fuel injection, in a case where the catalyst temperature is equal to or higher than the first threshold temperature.

2. The engine control device according to claim 1, wherein
the engine control device performs the compression release control, in a case where a coolant temperature of a coolant circulating inside a coolant circuit for cooling the engine is equal to or higher than a second threshold temperature and the catalyst temperature is lower than the first threshold temperature,
the engine control device performs the Miller cycle control, in a case where the coolant temperature is equal to or higher than the second threshold temperature and the catalyst temperature is equal to or higher than the first threshold temperature,
the engine control device performs the compression release control, in a case where the coolant temperature is lower than the second threshold temperature and the catalyst temperature is lower than a third threshold temperature higher than the first threshold temperature, and
the engine control device performs normal control of closing the intake valve when a piston is positioned near a bottom dead center and performing fuel injection when the piston is positioned near a top dead center in all of the plurality of cylinders, in a case where the coolant temperature is lower than the second threshold temperature and the catalyst temperature is equal to or higher than the third threshold temperature.

3. The engine control device according to claim 1, wherein
in the compression release control, an exhaust valve is opened when a piston is positioned near a top dead center during a compression stroke in the selected cylinder, and the exhaust valve is closed again during an expansion stroke.

4. The engine control device according to claim 2, wherein
the engine control device performs the normal control instead of the compression release control, in a case where at least one of a rotation speed of the engine, a requested output, and/or the amount of intake air does not match execution conditions of the compression release control, and
the engine control device performs the normal control instead of the Miller cycle control, in a case where at least one of the rotation speed of the engine and/or the requested output does not match execution conditions of the Miller cycle control.

5. The engine control device according to claim 2, wherein
the engine control device stops, when transitioning from the normal control to the compression release control, the fuel injection of the selected cylinder and performs the transitioning after increasing the amount of fuel injection in the non-selected cylinder, and
the engine control device restarts, when transitioning from the compression release control to the normal control or when transitioning from the compression release control to the Miller cycle control, the fuel injection in the selected cylinder after the transitioning and reduces the amount of fuel injection in the non-selected cylinder.

6. The engine control device according to claim 1, wherein
the engine control device performs, in the Miller cycle control, control of closing the intake valve later than in the compression release control, in an intake stroke.

7. The engine control device according to claim 2, wherein
the first threshold temperature is a temperature lower than the third threshold temperature.

8. A vehicle comprising the engine control device according to claim 1.

9. An engine control program causing a computer that controls an engine to perform:
compression release control of stopping fuel injection from an injector in a selected cylinder and increasing an amount of fuel injection in a non-selected cylinder different from the selected cylinder, in a case where a catalyst temperature of a catalyst for purifying exhaust gas of the engine is lower than a first threshold temperature, the selected cylinder being one or some of a plurality of cylinders included in the engine; and
Miller cycle control of operating an intake valve such that an amount of intake air is reduced in all of the plurality of cylinders as compared with the case where the catalyst temperature is lower than the first threshold temperature, and reducing the amount of fuel injection, in a case where the catalyst temperature is equal to or higher than the first threshold temperature.

10. An engine control method for controlling an engine, the engine control method comprising:
performing compression release control of stopping fuel injection from an injector in a selected cylinder and increasing an amount of fuel injection in a non-selected cylinder different from the selected cylinder, in a case where a catalyst temperature of a catalyst for purifying exhaust gas of the engine is lower than a first threshold temperature, the selected cylinder being one or some of a plurality of cylinders included in the engine; and
performing Miller cycle control of operating an intake valve such that an amount of intake air is reduced in all of the plurality of cylinders as compared with the case where the catalyst temperature is lower than the first threshold temperature, and reducing the amount of fuel injection, in a case where the catalyst temperature is equal to or higher than the first threshold temperature.
